(19) United States
(12) Patent Application Publication
(10) Pub. No.: US 2008/0021649 A1
(43) Pub. Date: Jan. 24, 2008

(54) Color sample clustering

(76) Inventors: Kua Seng Choy, Selangor (MY); Faizal Hussein, Selangor (MY)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/454,608

(22) Filed: Jun. 16, 2006

(51) Int. Cl. G06F 19/00

(52) U.S. Cl. 702/1

(57) ABSTRACT

A method, an apparatus, and a computer program product for color matching and/or indexing utilizing color sample clustering is generally disclosed. Other embodiments may be described and claimed.

### CROSS REFERENCE TO RELATED APPLICATION

The present application claims priority to Malaysian Patent Application No. ______, filed May 29, 2006, entitled “COLOR MATCHING UTILIZING COLOR SAMPLE CLUSTERING,” the entire contents of which are hereby incorporated by reference.

### BACKGROUND

With Internet access broadly available, individuals and businesses are embracing it as a new media of exchange. In color-critical industries, the process of color specification, color matching and color approval is increasingly being automated by digital means. In a non-digital world, the manual way of visually assessing, matching, and approving color involves humans. For example, a user would need to compare samples in a light box, or leaf through a color palette book to lookup similar or complementary colors. The manual process is subject to human interpretations and is inconsistent. The same person may approve a sample one day and fail it another. In contrast, a digital color matching and approval system eliminates human subjectivity. The system can quickly compare thousands of samples against a target and reduce the need to send physical samples, saving lead time and courier charges. Color matching and approval thus become a manageable and controllable process.

Many digital color matching and approval systems use the conventionally denoted dE (delta E) tolerance values to either pass or fail samples matched against a target in a color space. A color space is a model describing the way colors can be represented as tuples of numbers, typically as three or four values or color components. One can also think of a color space as a model for representing color in terms of intensity values. Different types of color spaces include: RGB-based color spaces (used mainly for displays and scanners), CMYK-based color spaces (used mainly for color printing) and device-independent color spaces used mainly for color models (L*a*b*, LCH, LUV, etc.). Visually, these spaces often correspond to various solid shapes, such as spheres, cubes, cones, or polyhedrons. For example, the RGB space is a three-dimensional color space whose components are the red, green, and blue intensities that make up a given color.

Conventional methods employed for digitally searching and matching colors are usually based on compacting a multidimensional color space using arrays, with each array holding color information for a specific combination of external factors affecting color perception. When these arrays are used, searching and matching a target with a large amount of samples with external factors accounted for is slow and inefficient, as numerous passes through these arrays are essential every time a search and compare is carried out.

### BRIEF DESCRIPTION OF THE DRAWINGS

FIG. 1 illustrates a color space diagram to be used in embodiments of this invention;

FIG. 2 illustrates sample clusters and a target color represented with a color space in accordance with an embodiment of this invention;

FIG. 3 illustrates a data storage structure including cluster attributes to facilitate searching and/or matching operations in accordance with an embodiment of this invention;

FIG. 4 illustrates another data storage structure including other color information to facilitate searching and/or matching operations in accordance with an embodiment of this invention;

FIG. 5 illustrates sample clusters and a complement of a target color represented within a color space in accordance with an embodiment of this invention;

FIG. 6 illustrates a color matching system in accordance with an embodiment of this invention;

FIG. 7 illustrates an indexing operation in accordance with an embodiment of this invention;

FIG. 8 illustrates a search and match operation in accordance with an embodiment of this invention; and

FIG. 9 illustrates a color matching device in accordance with an embodiment of this invention.

### DETAILED DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the present invention, the phrase “A/B” means A or B; the phrase “A and/or B” means “(A), (B), or (A and B)”; the phrase “A, B, and/or C” means “(A), (B), (C), (A and B), (A and C), (B and C), or (A, B and C)”; and the phrase “(A)B” means “(B) or (AB),” that is, A is an optional element.

The description may use the phrases “in an embodiment,” or “in embodiments,” which may each refer to one or more of the same or different embodiments.

Furthermore, the terms “comprising,” “including,” “having,” and the like, as used with respect to embodiments of the present invention, are synonymous.

In a color-critical industry employing digital color process (for example, textile and apparels), there may be thousands of color samples sitting in the organization's data storage. The amount of color samples may increase exponentially when considering and accounting for external factors that may affect the visual appearance of these samples. For example, different illuminations (e.g., D65, D55, F11 and others) on a surface can yield different visual appearance of colors. Other external factors such as, but not limited to, the observer (where the color perception of two people are different), field size (different observation angles), and geometry (different viewing geometries) may also influence the visual appearance of colors.

In various embodiments, the color samples may relate to colored goods such as, but limited to, substances (e.g., dyes, paints, and other substances used for coloring) and/or products (e.g., textiles, apparels, manufactured products, auto parts, toys, jewelry, accessories, etc.).

Embodiments of this invention may provide for an efficient arrangement of color information in a multi-dimensional color space to facilitate high-speed searching and comparison of color information, including complementary color matching, with external conditions factored in. Utilizing embodiments of the present invention, users may quickly search through a number of color samples and compare them against a target color. The target color may be a color inspiration for an upcoming season of apparels, for instance. The search and compare may allow the user to quickly determine if a matching and/or complementary color already exists in an organization's database of sample colors.

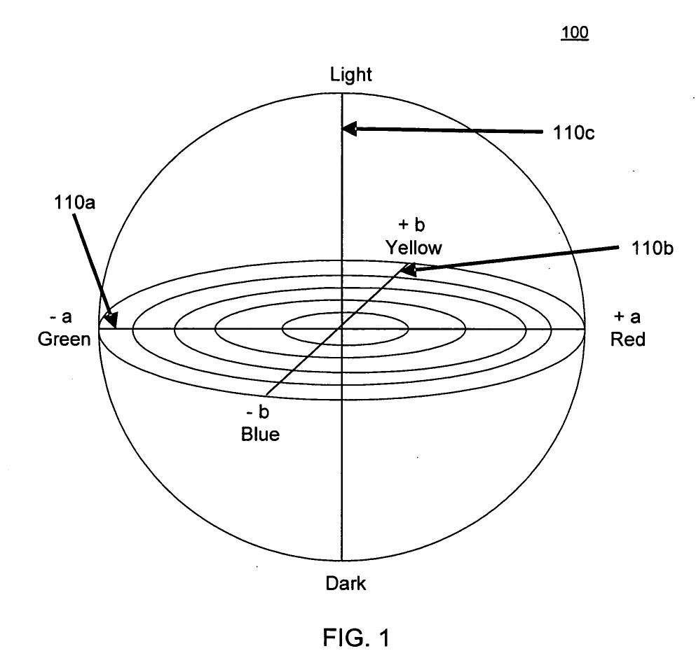

Referring now to FIG. 1, there is illustrated an example of a color space 100 for describing color in accordance with embodiments of this invention. This color space is known as the CIE L*a*b* and is one of the most widely used color spaces established by the Commission Internationale de l'Eclairage (CIE) (a.k.a. International Commission on Illumination), an organization devoted to international cooperation and exchange of information among its member countries on matters relating to the science and art of lighting and illumination. The CIE L*a*b* color space is a mathematical model describing color sensations (caused by light from a particular illuminant reflecting from an object with particular reflectance properties as measured by a reflectance curve, for example) and is based on the color describing theory of opponent colors. The concept follows that colors can be considered as combinations of red and green, yellow and blue, and dark and light.

Like most color spaces, the difference between colors in the CIE L*a*b* agree consistently well with human visual perceptions of the differences. A given color may be associated with a series of parametric measurements measuring red/green factor, blue/yellow factor, and dark/light factor. These measurements uniquely describe the color and can be represented as a point in a three-dimensional color space 100, where the red/green parametric measurement may be plotted as point on a red/green axis 110a, where the blue/yellow parametric measurement may be plotted as point on a blue/yellow axis 110b, and where the dark/light parametric measurement may be plotted as point on dark/light axis 110c.

Information in a color space may be indexed and stored as records in a data storage structure. The foregoing data storage structure may allow such records to be searched by the visual appearance of the colors. While embodiments of the present invention may be discussed with reference to the CIE L*a*b* color space, other embodiments may employ any n-dimensional color space where each point represents a color value.

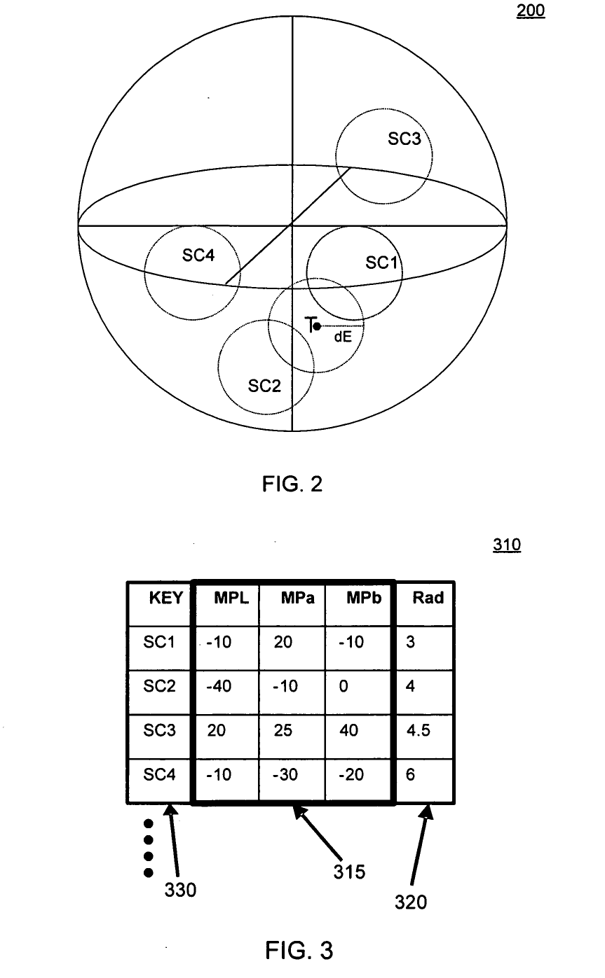

Referring now to FIG. 2, there is illustrated a diagram organizing color information for searching and matching in a color space 200, which may be a stripped-down diagram of color space 100, in accordance with an embodiment of this invention. The target T may be depicted as one instance of the many combinations of external factors influencing visual color perception. For example, the target T may depict a color measured with a D65 illuminant and 2 degree observer angle. The tolerance value for target T may be dE, which may be set by the user. The boundary outlined by dE may be spherical. This means any color samples found within the dE tolerance may be considered a match. On the other hand, color samples which fall outside the dE tolerance may not be considered a match.

Embodiments of this invention may cluster together a plurality of values in the color space 200 representing a particular color sample influenced by varying sets of external factors. For example, one color space value of a cluster may be determined by analyzing a color sample's spectral data under a first set of external factors, e.g., a first illuminant and a first angle. Another color space value of the cluster may be determined by analyzing the color sample's spectral data under a second set of external factors, e.g., a second illuminant and a second angle. As used herein, varying sets of external factors may be defined as at least two sets of external factors having at least one element which is different from the other set. These color sample clusters may be used to facilitate rapid searching and comparing of sample colors under different external factors.

A spherical boundary for each sample color cluster (e.g., SC1 to SC4) may be calculated and created such that it encompasses the plurality of values of the cluster. If a sample color cluster's spherical boundary happens to intersect the target T spherical boundary, there may be one or more colors in the cluster that fall within the target T's dE tolerance level. In the case of sample clusters in color space 200, SC1 and SC2 meet these criteria, and will be identified as potential matches for further processing. SC3 and SC4 do not meet these criteria, and will not be processed further.

Note that the dE boundary for target T as well as the sample color clusters (SC1 to SC4) in color space 200 need not be spherical in nature. The boundary shape may be determined by the type of color space. For simplicity in illustration and calculation, however, a sphere may be used. The same assertion may be said of other n-dimensional color spaces.

FIG. 3 illustrates a data storage structure 310 including cluster attributes to facilitate searching and/or matching operations in accordance with an embodiment of this invention. The data storage structure 310, which may also be referred to as the master array 310, may include cluster attributes representative of the sample clusters SC1-SC4 as they exist in the 3-D color space 200. The color attributes may be information about the sample clusters SC1-SC4, arranged by indices 330, including, e.g., the midpoints of each cluster 315 and its corresponding radius 320. This information may allow each cluster to define its spherical boundary, and to facilitate a high-speed computation of whether the clusters intersect with the boundary of the target T. In various embodiments, other cluster attributes may additionally/alternatively be stored in the master array 310 to allow for preliminary matching operations as will be described later.

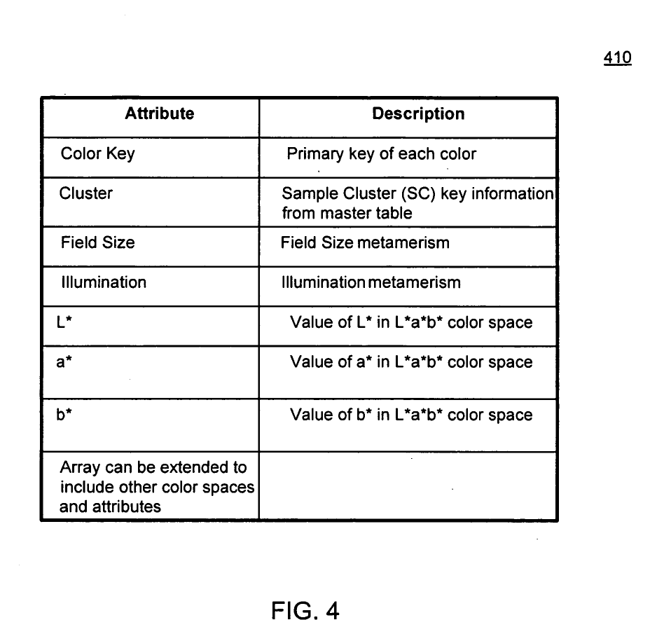

FIG. 4 illustrates another data storage structure 410, which may also be referred to as a secondary array 410, including further data for each color sample in accordance with an embodiment of this invention. Each index 330 in the master array 310 may be linked with one or more corresponding color keys in the secondary array 410. Index information from intersecting color sample clusters (e.g., SC1 and SC2) may be used with secondary array 410 to extract further data, e.g., detailed color information, about the corresponding color sample, while the rest of the nonintersecting cluster colors may be ignored. The further data of the corresponding color samples may be used to compute for color matches.

In various embodiments, the further data may include information on attributes of the color sample such as, but not limited to, color key attributes (for indexing), cluster attributes (e.g., sample cluster key information from the master array 310), color space values defined by, e.g., L*, a*, and b* values, for given external factors, e.g., field size and illumination. In various embodiments the secondary array 410 may be additional/alternative color spaces and/or attributes.

The master array 310 and secondary array 410 may be flexible enough to accommodate adding, updating or deleting additional color attributes. Adding additional external factors, for example, a new illuminant or field size to an existing color is as easy as adding the attribute to the secondary array 410 under an existing cluster. Adding a new cluster of sample colors entails adding an additional row to the master array 310 and creating one or more color information for the new cluster in secondary array 410.

Clustering colors under different external factors and storing them into master array 310 and secondary array 410 may facilitate searching and comparing sample colors against a target under different external conditions. In a single pass through the master array 310 intersecting sample color clusters may be identified and singled out for detailed color information drill-down using the secondary array 410.

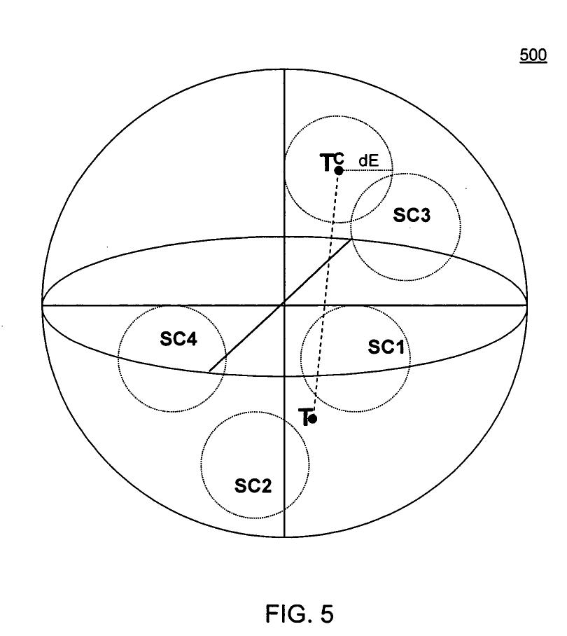

FIG. 5 illustrates sample clusters and a complement of a target color represented within a color space in accordance with an embodiment of this invention. Color space 500 may be similar to color space 200; however, color space 500 shows the original target T in color space 200 being projected to its complementary color, T^{C}. The tolerance value set by the user for target T^{C} may be dE. Again, note that the boundary outlined by dE is spherical. This means any sample colors found within the dE tolerance may be considered a match. On the other hand, samples which fall outside the dE tolerance may not be considered a match.

Similar to the above discussion with respect to FIG. 2, to enable rapid searching and comparing of sample colors under different external factors, different color measurements of external factors influencing the sample may be clustered together (e.g., SC1 to SC4) in color space 500. A spherical boundary for each sample color cluster (e.g., SC1 to SC4) may be calculated and created. If a sample color cluster's spherical boundary happens to intersect the target T^{C} spherical boundary, this means there may be one or more colors in the cluster that falls within the target T^{C}'s dE tolerance level. In the case of sample clusters in color space 500, SC3 meets these criteria, and may be singled out for further processing. SC1, SC2, and SC4 do not meet these criteria and may not need to be processed further.

It should be pointed out that in color space 500, T^{C} may include any color correlated to the target color, e.g., a complementary color, a contrast color, a triad color, a tetradic color, an analogic color, etc. Note that the dE boundary for target T^{C} as well as the sample color clusters (e.g., SC1 to SC4) in color space 500 need not be spherical in nature. The boundary shape is usually determined by the type of color space. For simplicity in illustration and calculation, however, a sphere is commonly used and accepted. The same assertion can be said of other n-dimensional color spaces.

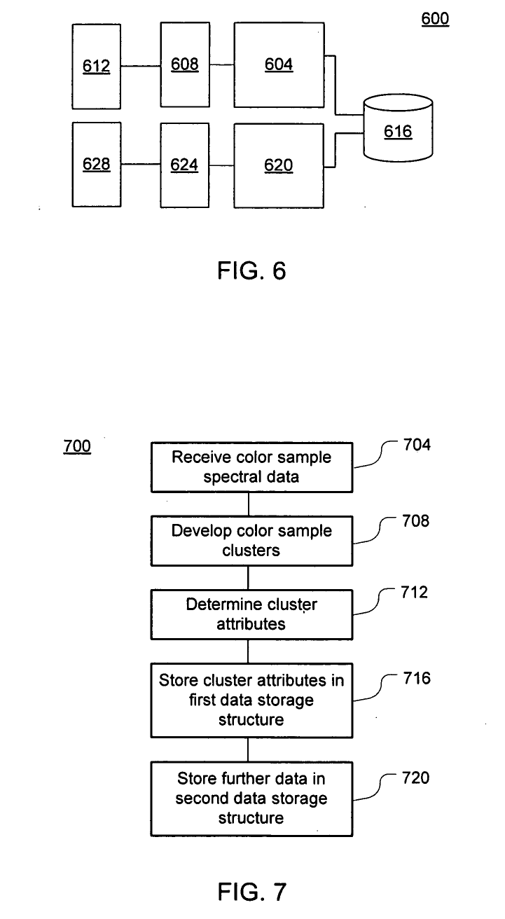

FIG. 6 illustrates a color matching system 600 in accordance with an embodiment of this invention. In this embodiment, an index module 604 may be coupled to a communication interface 608 to receive data on color samples to be indexed from a color input device 612. The color input device 612 may, for example, allow a seller of colored goods to upload color information relating to the colored goods to the color matching system 600. The index module 604 may organize the data to facilitate matching operations of embodiments of this invention. The organized data may be stored in a data storage device, e.g., database 616.

In an embodiment, the color matching system 600 may also include a search module 620 coupled to a communication interface 624 to receive search criteria from a search source 628, e.g., a search engine. The search source 628 may, for example, allow a potential buyer to input search criteria related to a sought colored goods. In various embodiments, the search criteria may include, e.g., target color data, tolerance levels, one or more illuminants (e.g., a primary illuminant and a secondary illuminant), etc. In some embodiments, the search criteria may also include non-color information, e.g., type of good, quantity, etc.

The search module 620 may be coupled to the database 616 and configured to identify the color samples matching the provided search criteria. Further operation of the components introduced in FIG. 6 may be discussed below in accordance with various embodiments.

In some embodiments, all of the components of the color matching system 600 may be co-disposed at the same site. In other embodiments, one or more components may be disposed remotely from other components and coupled to the other components via a private and/or public network, e.g., the Internet.

FIG. 7 illustrates an indexing operation 700 in accordance with an embodiment of this invention. In this embodiment, the index module 604 may receive color sample spectral data from the color input device 612 for a plurality of color samples, block 704. The index module 604 may then develop color sample clusters (e.g., SC1-SC4), block 708. As discussed above, each color sample cluster may include a plurality of values in a color space representing the particular color sample influenced by varying sets of external factors. The index module 604 may determine cluster attributes, block 712, and store said attributes in a first data storage structure, e.g., master array 310, block 716. The index module 604 may store further data on the color samples, e.g., more detailed information about the plurality of values in the color space, in another data storage structure, e.g., the secondary array 410, block 720.

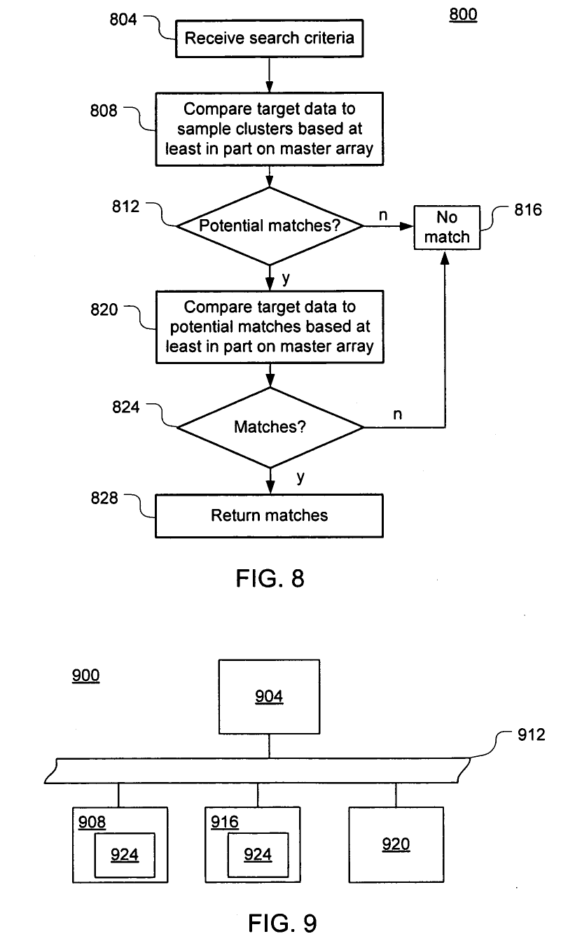

FIG. 8 illustrates a matching operation 800 in accordance with an embodiment of this invention. In this embodiment, the search module 620 may receive search criteria, including target data, from the search source 628, block 804. The search module 620 may compare target data to cluster attributes stored in the master array 310, block 808. This comparison may determine if any of the color samples are potential matches (e.g., they have the potential of satisfying the search criteria), block 812. If no potential matches are found, the search module 620 may return an indication of no matches to the search source 628, block 816.

If potential matches are found, the search module may compare the search criteria to further data of the potential matches found in the secondary array 410, block 820. This comparison may determine if any of the color samples are matches (e.g., they satisfy the search criteria), block 824. If matches are found, the matches may be returned to the search source 628, block 828. If no matches are found, an indication of such is returned, block 816.

In some embodiments, accompanying information may be returned to the search source 628 along with match information based at least in part on the match information and/or search criteria. For example, if search criteria includes a blouse of a target color, matching results may be accompanied by other information that may be of interest to the potential buyer, e.g., complementary bottoms for the blouse, other goods of that target color, etc.

FIG. 9 illustrates a computing device 900 capable of implementing various color match operations in accordance with various embodiments. As used herein “color match operations” may include indexing, organizing, arranging, matching, searching, and/or other operations as described herein. As illustrated, for the embodiments, computing device 900 includes processor 904, memory 908, and bus 912, coupled to each other as shown. Additionally, computing device 900 includes storage 916, and communication interface 920 coupled to each other, and the earlier described elements as shown.

Memory 908 and storage 916 may include temporal and persistent copies of color match logic 924, respectively. The color match logic 924 may include instructions that when accessed by the processor 904 result in the computing device 900 performing operations or executions described in accordance with embodiments of this invention. In particular, the accessing of the color match logic 924 by the processor 904 may facilitate indexing and/or searching operations as described above in connection with various embodiments.

In various embodiments, the memory 908 may include RAM, dynamic RAM (DRAM), static RAM (SRAM), synchronous DRAM (SDRAM), dual-data rate RAM (DDRRAM), etc.

In various embodiments, the processor 904 may include one or more single-core processors, multiple-core processors, controllers, application-specific integrated circuits (ASICs), etc.

In various embodiments, storage 916 may include integrated and/or peripheral storage devices, such as, but not limited to, disks and associated drives (e.g., magnetic, optical), universal serial bus (USB) storage devices and associated ports, flash memory, read-only memory (ROM), nonvolatile semiconductor devices, etc.

In various embodiments, storage 916 may be a storage resource physically part of the computing device 900 or it may be accessible by, but not necessarily a part of, the computing device 900. For example, the storage 916 may be accessed by the computing device 900 over a network.

In various embodiments, computing device 900 may have more or less elements, and/or different architectures.

Various embodiments have been described to efficiently organize, search, and compare color information based on multidimensional color space information. Sample colors under different illuminations, observers and other external factors that affect the visual appearance of colors may be clustered. This color information may then be compacted into a primary array permitting efficient search and a second array for further processing of color samples identified as potential matches.

Although embodiments of the present inventions have been illustrated in the accompanying Drawings and described in the foregoing Detailed Description, it will be understood that the inventions are not limited to the embodiments disclosed, but are capable of numerous rearrangements, modifications, and substitutions without departing from the spirit of the invention as set forth and defined by the claims and equivalents thereof.

What is claimed is:

1. An apparatus comprising:
a communication interface configured to receive spectral data on a plurality of color samples; and
an indexing module coupled to the communication interface and configured to develop a color sample cluster for each of the plurality of color samples based at least in part on the received spectral data.

2. The apparatus of claim 1, wherein the communication interface is further configured to receive a target color and the apparatus further comprises:
a search module coupled to the communication interface and configured to identify one or more of the plurality of color samples as matches for the target color based at least in part on one or more of the color sample clusters.

3. The apparatus of claim 1, wherein each color sample cluster comprises
a plurality of color space values of a predetermined color space to represent the color sample influenced by a variety of external factors.

4. The apparatus of claim 3, further comprising:
a database coupled to the indexing module and configured to store cluster properties for each of the color sample clusters.

5. The apparatus of claim 4, wherein the cluster properties of a given color sample cluster define a spatial occupation of the predetermined color space encompassing the plurality of color space values corresponding to the given color sample cluster.

6. The apparatus of claim 5, wherein the indexing module is further configured to store the cluster properties relating to each of the plurality of color samples in a first data storage structure in the database and further data relating to each of the plurality of color samples in a second data storage structure in the database.

7. The apparatus of claim 6, wherein the communication interface is further configured to receive a target color and the apparatus further comprises:
a search module coupled to the communication interface and the database and configured to identify one or more of the plurality of color samples as potential matches for the target color by reference to the first data storage structure.

8. The apparatus of claim 7, wherein the search module is further configured to identify one or more of the potential matches as matches for the target color by reference to the second data storage structure.

9. The apparatus of claim 5, wherein the communication interface is further configured to receive a target color and tolerance and the apparatus further comprises:
a search module coupled to the communication interface and the database and configured
to determine a spatial occupation of the target color within the predetermined color space based at least in part on the target color and tolerance; and
to identify one or more of the plurality of color samples as potential matches based at least in part on an overlapping of a corresponding one or more color sample cluster's spatial occupation with the target color's spatial occupation.

10. A method comprising:
receiving spectral data on a plurality of color samples; and
developing a color sample cluster for each of the plurality of color samples based at least in part on the received spectral data.

11. The method of claim 10, wherein said developing of a color sample cluster for each of the plurality of color samples comprises:
determining a plurality of color space values of a predetermined color space to represent the color sample influenced by a variety of external factors.

12. The method of claim 10, further comprising:
receiving a target color; and
identifying one or more of the plurality of color samples as matches for the received target color based at least in part on one or more of the color sample clusters.

13. The method of claim 12, further comprising:
storing cluster properties for each of the color sample clusters in a first storage structure of a database.

14. The method of claim 13, further comprising:
storing further data related to each of the plurality of color samples in a second data storage structure of the database.

15. The method of claim 14, wherein said identifying of one or more of the plurality of color samples as matches comprises:
comparing the target color to the cluster properties of each of the color sample clusters stored in the first storage structure;
determining a set of the plurality of color samples as potential matches to the target color based at least in part on said comparing of the target color to the cluster properties; and
comparing the target color to further data related to the set of the plurality of color samples to identify said one or more of the plurality of color samples as matches.

16. A machine accessible medium having associated instructions, which, when accessed, results in a machine:
receiving spectral data on a plurality of color samples; and
developing a color sample cluster for each of the plurality of color samples based at least in part on the received spectral data.

17. The machine accessible medium of claim 16, wherein the instructions, when accessed, further results in the machine:
receiving a target color; and
identifying one or more of the plurality of color samples as matches for the received target color based at least in part on one or more of the color sample clusters.

18. The machine accessible medium of claim 16, wherein the instructions, when accessed, further results in the machine:
determining a plurality of color space values of a predetermined color space to represent the color sample influenced by a variety of external factors.

19. The machine accessible medium of claim 16, wherein the instructions, when accessed, further results in the machine:
storing cluster properties for each of the color sample clusters in a first storage structure of a database.

20. The machine accessible medium of claim 19, wherein the instructions, when accessed, further results in the machine:
storing further data related to each of the plurality of color samples in a second data storage structure of the database.

21. The machine accessible medium of claim 20, wherein the instructions, when accessed, further results in the machine:
comparing the target color to the cluster properties of each of the color sample clusters stored in the first storage structure;
identifying one or more potential matches for the target color based at least in part on said comparing of the target color to the cluster properties; and
comparing the target color to further data related to the set of the plurality of color samples to identify said one or more of the plurality of color samples as matches for the target color.

22. An apparatus comprising:
a communication interface configured to receive a target color; and
a search module coupled to the communication interface and configured to identify one or more of a plurality of color samples as matches for the target color based at least in part on a plurality of color sample clusters corresponding to the plurality of color samples.

23. The apparatus of claim 22, wherein the search module is further configured to
compare the target color to cluster properties of the plurality of color sample clusters stored in a first data storage structure to identify one or more potential matches for the target color; and
compare the target color to further data related to the one or more potential matches stored in a second data storage structure to identify the one or more of the plurality of color samples as matches.

24. The apparatus of claim 23, further comprising:
a database having the first data storage structure and the second data storage structure.

25. The apparatus of claim 23, wherein the cluster properties describe spatial occupation of each of the plurality of color sample clusters in a predetermined color model and the search module is further configured to
receive a tolerance;
determine a spatial occupation of the target color within the predetermined color space based at least in part on the target color and the tolerance; and
to identify the one or more potential matches based at least in part on an overlapping of a corresponding one or more color sample cluster's spatial occupation with the target color's spatial occupation.
